(19) United States
(12) Patent Application Publication
(10) Pub. No.: US 2005/0098962 A1
(43) Pub. Date: May 12, 2005

(54) Elastomeric static gasket

(76) Inventors: Theodore G. Duclos, Ann Arbor, MI (US); Steve G. Koch, Gregory, MI (US); Mark A. Belchuk, Windsor (CA); Paul J. Hochgesang, Ann Arbor, MI (US); Frank A. Bentley, Alton, IL (US)

Correspondence Address: FREUDENBERG-NOK GENERAL PARTNERSHIP;INTELLECTUAL PROPERTY DEPT., 47690 EAST ANCHOR COURT, PLYMOUTH, MI, 48170-2455, US

(21) Appl. No.: 10/624,869

(22) Filed: Jul. 22, 2003

Related U.S. Application Data
(63) Continuation of application No. 09/616,834, filed on Jul. 14, 2000, now abandoned.

(51) Int. Cl. F16J 15/02

(52) U.S. Cl. 277/628

(57) ABSTRACT

The elastomeric static gasket is disclosed where a thin carrier is used to support a stopper member and an elastomeric seal member on the same surface of the carrier. An elastomeric seal is molded adjacent to the stopper. The stopper member acts as a compression limiter to limit the compressive forces on the seal. Preferably the stopper is an elastomer. Alternatively, the seal can be made with a different material than the stopper member. A variety of carrier members may be used in practicing the invention.

### FIELD OF THE INVENTION

The present invention is drawn to elastomeric static gaskets and specifically to elastomeric seals with compression limiters to prevent over compression of the seal.

### BACKGROUND OF THE INVENTION

Many sealing applications demand “thin” elastomeric static seals because of space limitations. This requirement often dictates the use of unsupported or homogeneous elastomeric seals. However, unsupported elastomeric seals are difficult to install in high production conditions especially if they fit into a shallow, narrow groove. This is because there is a tendency for the unsupported seal to pop out of the groove or for the seal to twist within the groove during installation. Either condition can result in a leak at the joint and/or damage to the mating component.

Other approaches include molding the seal into a groove. This solves the seal installation problem but this approach has been found to be too expensive for high volume applications. Another approach is the use of an elastomeric carrier gasket. An elastomer is molded into a groove or around the periphery of a metal or plastic carrier which is 3.0 mm thick to provide stiffness to the seal for ease of handling. This approach also has limitations in that these carriers are typically too thick for tight clearance applications. The thickness of the 3.0 mm carrier is unsatisfactory for multi-stack applications where overall length of the sealed unit must be kept to a minimum or for sealing powertrain components with height or length packaging constraints.

Thus, none of the prior art designs have been found to be satisfactory for applications with tight clearance requirements and there exists a need for a thin gasket with an overall compressed thickness in the order of 0.015 mm to 1.75 mm.

### SUMMARY OF THE INVENTION

The present invention seeks to overcome the difficulties of the prior art designs by providing a thin elastomeric static gasket that is capable of providing a seal or gasket which provides an effective seal for clamped multi-stack applications or for powertrain components with tight packaging constraints when a clamp load is applied to the gasket.

The static gasket includes a thin carrier member with a surface and a thickness that is less than 1.0 mm. A first stopper member is adjacent the carrier member. An elastomeric seal member is formed on the surface of the carrier member. The stopper member prevents the seal member from being over compressed when the gasket is subjected to a clamp load.

It is an object of the present invention to provide an elastomeric static gasket with a thin carrier that is less than 1.0 mm thick with a compression limiter to prevent the seal from being over compressed when the gasket is subjected to a clamp load.

It is another object of the present invention to provide a static gasket with a pair of stopper members which prevent the elastomeric sealing bead on a thin carrier from extruding out of the seal cavity between the stopper members when a clamp load is applied to the gasket.

It is another object of the present invention to provide a static gasket with a pair of spaced apart stopper members on a thin carrier that form a cavity into which an elastomeric seal is formed. Each of the pair of stopper members forms a stop which prevents the seal member from substantially increasing the width of the cavity when the elastomeric seal is compressed by a clamping load.

It is still another object of the present invention to provide an elastomeric stopper member on a thin carrier of less than 1.0 mm thick between seals to prevent over compression of the seals.

A still further object of the invention is to provide a method of forming a gasket on a thin carrier of less than 1.0 mm thick with a compression limiter.

These and other features of the present invention will become apparent from the subsequent descriptions and drawings.

### BRIEF DESCRIPTION OF THE DRAWINGS

FIG. 1 is a planar view of the preferred embodiment of the invention;

FIG. 2 is a cross sectional view along 2-2 of FIG. 1;

FIG. 3 is a cross sectional view along 3-3 of FIG. 1;

FIG. 4 is an enlarged view of Circle 5 in FIG. 2;

FIG. 5 is an enlarged view of Circle 4 in FIG. 3;

FIG. 6 is a cross sectional view of the elastomeric static gasket according to the preferred embodiment of the invention in between two opposite surfaces showing the elastomeric seal on the top surface of the carrier being uncompressed and the elastomeric seal on the opposite surface of the carrier being in a compressed condition;

FIG. 7 is a cross-sectional view of the method of making the preferred embodiment of the gasket according to the invention; and

FIG. 8 is a cross-sectional view of an alternative embodiment of the gasket of the present invention.

### DETAILED DESCRIPTION OF THE PREFERRED EMBODIMENT

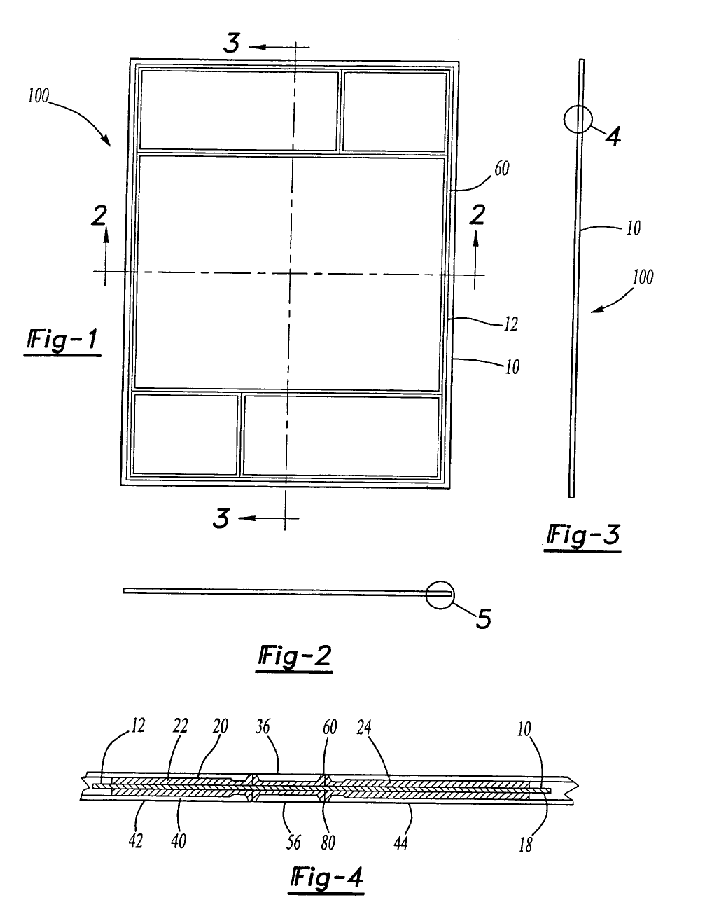

FIGS. 1-6 show an elastomeric static gasket according to the present invention, designated by the numeral 100. The invention is drawn to both the apparatus and the process for making the gasket 100. The gasket 100 seals fluid. The fluid may be a gas or liquid, a mixture of both, or solid particles entrained in a fluid such as dust in air or dirt in air. A liquid may be water, oil, fuel, anti-freeze, air conditioning fluid or any other similar material. The gas may be water vapor, hydrogen, air, oxygen, nitrogen, carbon dioxide, air conditioning vapor, fuel vapor, lubricating vapor or any other similar material.

Preferably, the static gasket has a carrier 10, a first pair of stopper members 20, a second pair of stopper members 40, a first elastomeric seal 60 and a second elastomeric seal 80. The gasket is formed with a thin carrier 10 that is less than 1.0 mm thick. The preferable thickness of the carrier, which is not to be taken as a limitation of the scope of the invention, is between 0.01 mm to 0.75 mm and preferably it is between 0.05 mm to 0.5 mm. The carrier is preferably made of a polymeric material such as Nylon®, Mylar®, Kapton®, polybutylene terephthalate (PBT), polyethylene naphtlate (PEN) or polyethylene terephathalite (PET). Nylon®, Mylar®, Kapton® are registered trademarks of DuPont. Alternatively, the carrier 10 can be made of a polymer material such as polyester, polyamide, silicone, polyimide, polyethersulphone, or a thin layer of metal such as steel, brass, aluminum, magnesium or stainless steel, or a gas diffusion layer, a graphite plate, a proton exchange membrane, a layer of non-woven material, a fiber board used in making cellulose composite gaskets, a woven fabric, a rubber coated metal layer, a ceramic layer, or any other material suitable for practicing the invention. The layer of non-woven material may be made of polyester, polyolefin, metal or ceramic or any other material suitable for the application. The carrier material is preferably a compliant material which is stiffened by the forming of an elastomeric seal and stopper members that add sufficient stiffness to the gasket to facilitate handling and assembly. Alternatively, the carrier material may be relatively non-compliant to facilitate handling and assembly in the application. The ultimate choice of compliance of the carrier material is made by taking into account the temperature, fluid medium to be sealed and the application constraints including geometry, ease of assembly and the material used in making the mating components.

As best shown in FIGS. 4, 5, and 6, the carrier 10 has a top surface 12 and an opposite surface 18. Preferably, a first pair of stopper members 20 are formed or molded of a polymeric material onto the top surface 12. The pair of stopper members 20 consists of two spaced apart relatively flat compression limiters or stops 22, 24, respectively. In between the stops 22, 24, respectively is a first void or first cavity 36. The cavity 36 that is formed between the two stops 22, 24 is a volumetric space (a width, a height and a length), as is well known in the art.

In between the stops 22, 24, respectively, a first rubber elastomeric seal 60 is molded, formed, attached, disposed, applied or inserted into the cavity 36 preferably in the form of a void-volume seal 78. A void-volume seal is one which is formed with the cavity or void 36 being greater than the maximum volume of the seal 60 when compressed into the cavity 36. This permits the elastomeric seal 60 to expand due to swelling or temperature expansion or chemical interactions without extruding out of the cavity 36. The bead is preferably in the shape of a triangle with its base contiguous to the top surface 12 of the carrier 10. Optionally, the shape of the seal 60 is a semicircle on a flat planar surface which is contiguous to the top surface 12 of the carrier 10. Further optionally, any other bead configuration in the elastomer seal that produces an adequate sealing force, such as rectangular, square, polygonal, semi-elliptical, semi-oval, semi-round, truncated triangular or any other shape may be used as long as it prevents the migration of fluid across the seal, would be suitable for the application in practicing the invention. In the uncompressed state, the seal 60 has at least one bead 62 with an apex 64 which is higher than the height 27, 29, respectively, of the stops 22, 24, respectively, above the surface 12. In the compressed state, that is when the seal 60 is clamped against a mating surface to seal it by a clamp load imposed on the mating surfaces, the bead 62 is compressed into the cavity 36. Because the seal is made of an elastomer or rubber which is incompressible, the rubber will conform to the volume in the space in the cavity 36 when a clamp load is applied to the gasket 100. If the volume of the cavity 36 is smaller than the seal volume, the elastomer will extrude out of the cavity. Thus, the space in cavity 36 is designed to be 100.1% to 130% of the volume of the seal. Preferably, the volume in space in the cavity is between 105% to 110% of the volume of the seal. The compression on the bead 62 may be compressed up to 80% from the apex 64 to the surface of the carrier and preferably from 1.5% to 75%.

The relatively flat surfaces 26, 28, respectively, of the polymeric stops 22, 24 respectively will compress somewhat under load. At the same time, the faces or sides 23, 25 respectively, of the stops 22, 24 respectively, are designed not to bulge substantially by careful selection of shape factor of the stops 22, 24 respectively, and their material properties. The sides 23, 25, respectively, are preferably sloping away from the top surfaces 26, 28 respectively. Optionally, they may be substantially perpendicular to the top surfaces 26, 28 and are designated as 23′, 25′, respectively. The stops 22, 24 respectively, are preferably made of the same material as the seal but the stops may be made of a higher durometer elastomer than the elastomer bead 62, or optionally, made of polymers such as thermoplastic, thermoset plastic or thermoplastic elastomers or, further optionally, made of suitable layers of metal, ceramic or composite fiber board. The elastomer bead 62 must be more compliant than the stops 22, 24, respectively. When the gasket is subjected to a clamp load, the seal 60, by being more compliant, will create a high line sealing pressure at the apex 64 of the bead 62 which prevents the migration of fluid past it without requiring a correspondingly high sealing force (load) against the entire mating surface of the component which is to be sealed. This is desirable in certain applications such as fuel cells where a seal pressing against a brittle component such as graphite bipolar plate can create high stress in the plate and can cause the plate to crack. A seal can crack a mating plate if the sealing force exceeds the plate's material strength capability.

As stated earlier, preferably, the stops, 22, 24, respectively, and the elastomeric bead 60 are formed of the same polymeric material. Alternatively, the stops 22, 24, respectively, may be made of a different polymer than the material used to form the elastomeric bead 60, such as silicone, fluorosilicone, butyl, natural rubber, fluorocarbon, ethylene-acrylate, polyacrylate, fluoropolymer, isoprene, epichlorohydrin, EPDM, nitrite, hydrogenated nitrite (HNBR), TPE or any other polymer which is suitable for practicing the invention. The preferred polymers used in forming the elastomer seal 60 and stops 22, 24, respectively are reaction cured. Reaction cured elastomers include addition ion, catalytic, ultraviolet, infra-red radiation, condensation and free radial cure. In using conventional reaction cured elastomers, a primer coat or adhesive may be applied to the carrier to enhance the bond of the elastomer to the carrier. The primer coat may be silane based or a phenolic resin. Silane based and phenolic resin primers are well known in the art and are used extensively with elastomers. Examples of silane based primers are: General Electric Company of Waterford, N.Y., Product No. SS4155; Dow Chemical Company of Midland, Mich., Product No. 3-6060; Rohm & Hass of Philadelphia, Pa., Thixone Product Number 304 and Lord Corporation, of Erie, Pa., Chemlock Products Numbers 607 and 608. Rohm & Haas also produces Solvent Based Product Numbers 2000, 05N-2, P15, 300, 715, 720 and Thixon® Water Based Products Numbers 2500, 7002, 7010, 7011 and 7015. Other primer coats are well known in the art. Thixon® is a registered trademark of Rohm & Hass. Optionally, the elastomers may be self bonding which eliminates the need to apply a primer coat or adhesive to enhance bonding of the elastomer to the surface of the carrier 10. Examples of self bonding silicone elastomers are available from Wacker Silicones of Adrian, Mich., Product Serial Nos. LR 3070, LR 3071, LR 3072, and LR 3073. Self bonding silicone elastomers are made by ShinEtsu of Tokyo, Japan and General Electric Co. Other self bonding elastomers include nitrile, HNBR, EPDM, butyl, fluorocarbon, ethylene acrylate, fluoropolymers, fluorosilicone, isoprene, and epichlorohydrin.

The height of the first and second members 22, 24, respectively, is preferably substantially the same. However, if the compressive load on the first member is higher than on the second member, it may be desirable to make the compressed height of the first stopper member different than the compressed height of the second stopper member. This difference in compressed height of the first stopper member 22 and the compressed height of the second stopper member 24 does not affect the inventive concept so long as the volume in the cavity 36 is not less than 100.1% of the maximum volume of the seal.

The gasket 100 heretofore has been described in the context of the construction of the seal 60 and a first pair of stopper members 20 on the top surface 12 of the carrier 10. Similarly, the bottom surface 18 of the carrier 10 preferably has a mirror-like construction similar to that described for the top surface 12. Thus, a second seal 80 and a second pair of stopper members 40 are formed or molded onto the opposite surface 18. The stopper members 40 include stops 42, 44, respectively, which are spaced apart to form a second cavity or void 56. Preferably, the stops 42, 44, respectively, have sides 43, 45, respectively, which are substantially perpendicular to the carrier 10, and heights 47, 49 respectively, which extend above the bottom surface 18. Alternatively, the sides are sloping (not shown) or slightly tapered. The second elastomeric seal 80 has at least one bead 82 which has an apex 84 to form a void-volume seal 98. Thus, the bottom portion of the gasket 100 has a mirror-like construction as to the top portion and the seal 80 and stops 42, 44, respectively, function in a similar manner to that described for the seal 60, stops 22, 24, respectively, and top surface 12 of the carrier 10.

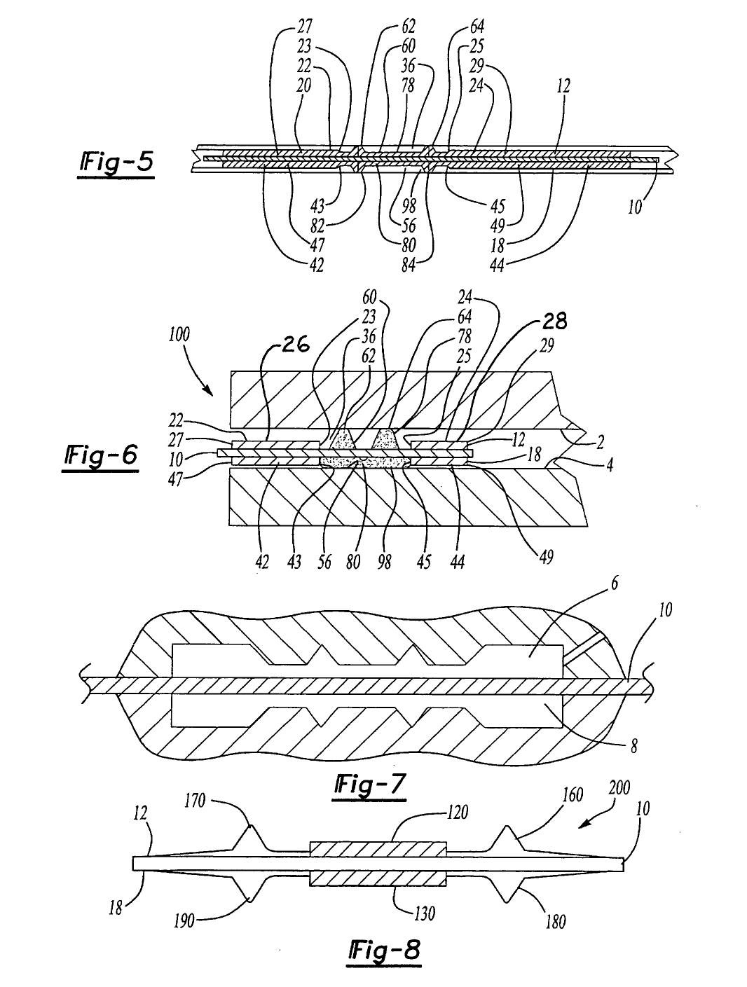

As stated earlier, the preferred construction of the gasket is a mirror image construction (that is the configuration on the one side of the carrier is identical to the opposite side) so that when the gasket 100 is compressed or clamped between mating surfaces such as one surface 2 and an opposite surface 4, the reactive forces are similar on each side of the carrier 10. This balances the forces on the carrier 10 and permits the use of “thin” carriers. The top half portion of FIG. 6 shows the stopper members 20 in an uncompressed state while stopper members 40 in the lower half of FIG. 6 are in a compressed state. Additionally, this construction minimizes the formation of bending stresses in mating brittle materials which can cause cracks or breaking of such brittle materials. The overall compressed thickness of the gasket 100 is preferably in the range of 0.015 mm to 1.75 mm.

Where the construction of the seals or stops is not identical on each side of the carrier, a somewhat thicker or less compliant carrier member may be required to accommodate the reactive forces. However, the function of the stopper members as compression limiters or stops is still to limit the compressed height of the seal and in a construction which has the seal between a pair of stops, the stops also function to prevent the seal from extruding out of the cavity. Thus, the function of the stopper members remains the same as previously described.

In the preferred construction, the stopper members 20, 40, respectively are made of an elastomer and sized with a shape factor along with the elastomer's material properties, such as Durometer number, so as to limit the bulging of the faces 23, 25, respectively as a compressive load is applied to the stopper members 20, 40, respectively. Shape factor is defined as the ratio of the area of one loaded elastomeric face divided by the total area of the elastomer which is free to bulge, as defined in the American Chemical Society, Rubber Division, of Akron, Ohio, Intermediate Rubber Course, Edited 1985, which is incorporated herein by reference. Bulging is a term used in elastomeric technology to denote the distortion of the unloaded side faces of an elastomeric member in response to a load applied on the top elastomeric face of the member. The range of shape factors in practicing the invention is between 0.1 to 100, more preferably it is between 0.15 to 10 and, most preferably, the range is 0.2 to 1.0.

In making the elastomeric static gasket 100, the carrier 10 is clamped between one mold half 6 and the other mold half 8 of a conventional molding machine as shown in FIG. 7. If a conventional elastomer is used, then an adhesive coat is applied to the surface of the carrier prior to molding prior to receiving the elastomer. If a self-bonding elastomer is used, it may not be necessary to use a separate adhesive coating on the surface of the carrier. The uncured polymer or elastomer material is dispensed into the cavity through a hole in the mold so that the elastomer flows into the space between the carrier 10 and into the cavity halves 6, 8, respectively, so as not to deform the carrier. The polymeric or elastomeric material is heated in order to enhance flow into the cavity. The polymeric material is at a sufficient temperature so as to cure the polymer to form elastomeric sealing members 60, 80, respectively and the first stopper member 20 and second stopper member 40. Alternatively, a polymer material may be deposited, injected, transferred, formed in place, applied by roll coating or screen printed onto the top surfaces 12 and bottom surface 18 of the carrier 10 to form the elastomeric sealing members 60, 80, respectively. Those skilled in the art will recognize that there may be certain applications where only one elastomeric sealing member need be formed on the carrier 10 and thus an elastomeric sealing member 60 is formed on only the top surface 12 of the carrier. In this configuration of the gasket 100, a pressure sensitive adhesive may optionally be applied to the opposite side 12 of the carrier 10 to aid in assembly of the gasket to one mating surface and bond to it so as to seal against the one mating surface. Alternatively, the first and second stopper members are formed of other polymers or a layer of metal, ceramic or composite fiber board, as described earlier.

An alternate embodiment of the present invention is shown in FIG. 8 and the gasket is designated by the numeral 200. Where the elements are the same as in gasket 100, the numerals remain the same.

The gasket 200 includes a thin carrier 10, a first stopper member 120, a second stopper member 130 and a first sealing member 160, a second sealing member 170, a third sealing member 180 and a fourth sealing member 190. The carrier 10 has a top-surface 12 and an opposite surface 10. The first stopper member 120 is formed on the top surface 12 and the second stopper member 130 is formed on the opposite surface 18. The first sealing member 160 is on the top surface 12 and adjacent to one side of the first stopper member 120. The second sealing member 170 is on the top surface 12 and adjacent to the other side of the first stopper member 120. The third sealing member 180 is on the bottom surface 18 and adjacent to one side of the second stopper member 130. The fourth sealing member 190 is on the bottom surface 18 and adjacent to the other side of the second stopper member 130. Preferably, the first stopper member 120 is opposite the second stopper member 130 and the first and second sealing elements 160, 170, respectively, are opposite the third and fourth sealing elements 180, 190, respectively. The sealing elements 160, 170, 180 and 190, respectively, are preferably made of elastomeric materials as previously discussed for seal 60 and seal 80 in the preferred embodiment. Likewise, the first stopper member 120 and the second stopper member 130 are preferably made of the same materials as discussed for the first pair of stopper members 20 and the second pair of stopper members 40 in the preferred embodiment. Optionally, the first stopper member 120 and the second stopper member 130 may be made of plastic, metal, ceramic or composite fiber board as discussed earlier in the preferred embodiment.

In this alternative embodiment, the first stopper member 120 functions as a compression limiter to prevent over compression of the first sealing member 160 and the second sealing member 170 on the one side of the carrier 10. Similarly, the second stopper member 130 functions as a compression limiter to prevent over compression of the third sealing member 180 and the fourth sealing member 190 on the other side of the carrier 10.

In all other aspects, the stopper members 120, 130, respectively, function similarly to the stopper members 20, 40, respectively except that the stoppers 120, 130, respectively do not form a cavity since only one stopper per side of carrier 10 is provided.

The width of the stopper members 120, 130, respectively, is designed to accommodate the sealing load exerted by the mating component (not shown) which is being sealed. The stopper members 120, 130, respectively by absorbing most of the clamp load exerted by the mating component, prevent the over compression of the sealing members 160, 170, 180 and 190, respectively, so that the sealing members maintain a high line sealing force against the mating component to prevent the migration of fluid across the seal.

In addition to the previously described applications, the gasket according to the present invention has use in other applications such as in water pumps, front covers, cam covers, throttle bodies, carburetors, rocker covers, fuel valves, flexible printed circuits, air conditioning units, intake manifolds, water outlet connectors, thermostat housings, oil pans, and between two mating flanges where the thickness of the gasket must be minimized because of application restrictions.

While the invention has been described with a preferred and alternative embodiments, it is not intended to limit the scope of the invention to the embodiments disclosed but to embrace all variations within the scope of the appended claims.

1. A static gasket adapted to seal between a first sealing surface and an opposed second sealing surface that are secured together such that a clamp load is applied to the static gasket by the first and second sealing surfaces the static gasket comprising:
a relatively thin carrier member having a top surface facing the first sealing surface and an opposite surface facing the second sealing surface;
a first stopper member located on said top surface;
a second stopper member on said top surface in spaced relationship to said first stopper member; said first and second stopper members forming a cavity therebetween, with each having a height above said top surface; and
an elastomeric seal member located in said cavity, said elastomeric seal member having at least one sealing bead, said sealing bead having an apex which extends from said top surface and is greater than said height of said first and second stopper members, and said apex is adapted to compress to said height of said first and second stopper members, with said first stopper member and said second stopper member preventing said seal member from being over compressed while the gasket is subjected to the clamp load from the first sealing surface and the second sealing surface.

2. A gasket as claimed in claim 1 wherein said at least one sealing bead has a shape selected from a group consisting of rectangular, square, triangular, void-volume, polygonal, semi-oval, semi-elliptical, semi-round, and truncated triangular.

3. A gasket as claimed in claim 1 wherein the volume of said cavity is greater than the volume of the elastomeric seal member.

4. A gasket as claimed in claim 1 wherein said elastomeric seal member is formed of a polymer material selected from the group consisting of fluorocarbon, silicone, fluorosilicone, butyl, ethylene propylene diene monomer, ethylene-acrylate, polyacrylate, isoprene, perfluoropolymer, natural rubber, epichlorohydrin, nitrile, hydrogenated nitrile and thermoplastic elastomer.

5. A gasket as claimed in claim 1 wherein said carrier member has a thickness of less than 1.0 mm.

6. A gasket as claimed in claim 1 wherein said carrier member has a thickness of 0.01 mm to 0.75 mm.

7. A gasket as claimed in claim 1 wherein the height of said first stopper member and the height of said second stopper member are at different.

8. A gasket as claimed in claim 1 wherein said first stopper member and said second stopper member are made of a material selected from the group consisting of a polymer, metal, ceramic and composite fiber board.

9. A gasket as claimed in claim 1 wherein said apex is compressed between 1.5% to 70%.

10. A static gasket adapted for sealing between two opposed mating surfaces, said static gasket comprising:
a carrier member having a top surface and an opposite surface;
a first pair of stopper members on said top surface, one of said first pair of stopper members in spaced relation to the other of said first pair of stopper members, the one and the other of said first pair of stopper members having a first height above said top surface;
a second pair of stopper members on said opposite surface, one of said second pair of stopper members in spaced relation to the other of said second pair of stopper members, the one and the other of said second pair of stopper members having a second height above said opposite surface;
a first elastomeric sealing member on said top surface and interposed said first pair of stopper members, said sealing member having at least one bead; and
a second elastomeric sealing member on said opposite surface and interposed said second pair of stopper members, said second elastomeric sealing member having at least one sealing bead;
whereby when said first and second elastomeric sealing members are adapted to be clamped between the two opposed mating surfaces under a clamp load such that, said at least one bead of said first elastomeric member is compressed to said first height and said at least one bead of said second elastomeric member is compressed to said second height, so that said first pair of stopper members and said second pair of stopper members limit the compression on said first and second elastomeric sealing members, respectively.

11. An elastomeric static gasket as claimed in claim 10 wherein at least one of said first and second said elastomeric sealing members has a cure system selected from a group consisting of addition ion cure, condensation cure, free radical cure, catalytic cure, infra-red radiation cure and ultraviolet cure.

12. (canceled)

13. A static gasket as claimed in claim 10 wherein said carrier member has a thickness between 0.01 mm to 1.0 mm.

14. A static gasket as claimed in claim 10 wherein said carrier member is selected from a group consisting of a polymeric layer, a layer of woven fabric, a layer of non-woven fabric, a layer of metal, a gas diffusion layer, a graphite plate, a proton exchange membrane, a composite fiber board, rubber coated metal layer, and a ceramic layer.

15. A static gasket as claimed in claim 10 wherein said first pair of stopper members has a shape factor between 0.15 to 10.

16. (canceled)

17. A static gasket adapted to seal between a first sealing surface and an opposed second sealing surface that are secured together such that a clamp load is applied to the static gasket by the first and second sealing surfaces, the static gasket comprising:
a relatively thin carrier member with a first surface adapted to face said first sealing surface and a second surface adapted to face said second sealing surface;
a first stopper member located on said first surface and having a first height above the first surface; and
an elastomeric seal member formed on said first surface of said carrier member adjacent to said first stopper member and having a second height above said first surface that is greater than said first height said first stopper member adapted to prevent said seal member from being over compressed while the gasket is subjected to a the clamp load from the first sealing surface and the second sealing surface.

18. The static gasket as claimed in claim 17 wherein said first stopper member includes a pair of spaced compression limiters forming a cavity therebetween, with the elastomeric seal located in the cavity.

19. The static gasket as claimed in claim 17 wherein said first stopper member is molded on said carrier member.

20. The static gasket as claimed in claim 17 further comprising:
an adhesive layer on said second surface of said carrier member.

21. The static gasket as claimed in claim 17 wherein said first stopper member is formed of a material selected from a group including a polymer, metal, ceramic and composite fiber board.

22. The static gasket as claimed in claim 17 further comprising:
a second stopper member located on said second surface and having a first height above the second surface; and
a second elastomeric seal member formed on said second surface adjacent to said second stopper member and having a second height above said second surface that is greater than said first height above the second surface, said second stopper member adapted to prevent said second seal member from being overcompressed while the gasket is subjected to the clamp load from the first sealing surface and the second sealing surface.

23. The static gasket as claimed in claim 17 wherein said thickness of said carrier member is between 0.01 mm to 0.75 mm.

24. The static gasket as claimed in claim 17 wherein said first stopper member is formed of an elastomeric material, said elastomeric material having a shape factor between 0.15 to 10.

25. The static gasket as claimed in claim 22 wherein said second stopper member includes a pair of spaced compression limiters forming a second cavity therebetween, with the second elastomeric seal located in the second cavity.

26-39. (canceled)

40. The static gasket as claimed in claim 17 wherein the carrier member has a thickness, and the elastomeric seal member has a thickness that is greater than the thickness of the carrier member.
